(19) United States
(12) Patent Application Publication
(10) Pub. No.: US 2015/0067084 A1
(43) Pub. Date: Mar. 5, 2015

(54) SERVER SYSTEM AND REDUNDANT MANAGEMENT METHOD THEREOF

(71) Applicant: Wistron Corporation, New Taipei City (TW)

(72) Inventors: Chun-Chieh Yeh, New Taipei City (TW); Ming-Sheng Wu, New Taipei City (TW); Hsin-Jung Hsu, New Taipei City (TW); Wei-Chih Chen, New Taipei City (TW)

(73) Assignee: Wistron Corporation, New Taipei City (TW)

(21) Appl. No.: 14/177,243

(22) Filed: Feb. 11, 2014

(30) Foreign Application Priority Data
Sep. 3, 2013 (TW) 102131731

(51) Int. Cl. H04L 29/08; H04L 12/24

(52) U.S. Cl. CPC H04L 67/02; H04L 41/04
USPC 709/209; 709/219

(57) ABSTRACT

A server system and a redundant management method are provided. The server system includes a first central management board (CMB), a second CMB, a server and a redundant circuit board (RCB). The RCB includes a communication bus, a shared storage device, a storage switch circuit, and a redundant switch module. The communication bus communicates the first CMB with the second CMB. The storage switch circuit connects the shared storage device to the first CMB or the second CMB. The first CMB or second CMB acquires the system mastery of the server via the redundant switch module.

This application claims the benefit of Taiwan application Serial No. 102131731, filed Sep. 3, 2013, the subject matter of which is incorporated herein by reference.

### BACKGROUND OF THE INVENTION

1. Field of the Invention

The invention relates in general to an electronic apparatus, and more particularly to a server system and a redundant management method thereof.

2. Description of the Related Art

With the progress and development of network technologies, the application range of servers continues to expand at an ever-growing utilization magnitude. Managing distributed server chassis and large-sized machine rooms in an effective manner can be consuming in both time and effort. Not only colossal numbers and diversified types of server chassis need to be properly handled, but also efficiently differentiating functioning and malfunctioning server chassis is required.

A central management board (CMB) is for monitoring and managing information within an entire server system. A user may monitor and manage a remote system via a network connector of the CMB to thus reduce the management need that local systems demand of the user. From perspectives of a system or a user, a CMB malfunction during system executions cannot be tolerated, or else distortion on the information managed will be incurred. Once the malfunction occurs, management complications are caused to even lead to severe system damages. Therefore, there is a need for a redundant mechanism that appropriately hands over the server from a current CMB to another CMB in the event of a malfunction of the current CMB.

### SUMMARY OF THE INVENTION

The invention is directed to a server system and a redundant management method thereof.

A server system is provided by the present invention. The server system includes a sensor, a first central management board (CMB), a second CMB, a server and a redundant circuit board (RCB). The sensor generates sensing data. The RCB includes a communication bus, a shared storage device, a storage switch circuit, and a redundant switch module. The communication bus communicates an external server with the first CMB and the second CMB. The storage switch circuit is controlled by the first CMB or the second CMB, and connects the shared storage device to the first CMB or the second CMB. The first CMB or second CMB acquires the system mastery of the server via the redundant switch module.

A server system is further provided by the present invention. The server system includes a sensor, a first CMB, a second CMB, a server and an RCB. The sensor generates sensing data. The first CMB and the second CMB are connected to the sensor. When the first CMB enters an active mode and the second CMB enters a sync standby mode, the first CMB outputs a heartbeat signal to the second CMB, and synchronizes status data to the second CMB. In the active mode, the first CMB takes over the server and outputs a control signal to control the server. The RCB includes a communication bus. The communication bus communicates the first CMB with the second CMB.

A redundant management method for a server system is further provided by the present invention. The server system includes a sensor, a first CMB, a second CMB and an RCB. The RCB includes a communication bus. The communication bus communicates the first CMB with the second CMB. The redundant management method includes: generating sensing data by the sensor; and, when the first CMB enters an active mode and the second CMB enters a sync standby mode, outputting a heartbeat signal to the second CMB and synchronizing status data to the second CMB by the first CMB. In the active mode, the first CMB takes over the server and outputs a control signal to the server.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a server system according to a first embodiment;

FIGS. 2A and 2B are flowcharts of a redundant management method for a server system according to the first embodiment;

FIG. 3 is a schematic diagram of a first baseboard management controller (BMC) 111, a second BMC 121, a server 13 and a redundant switch module 144;

FIG. 4 is a schematic diagram of a server system according to a second embodiment;

FIG. 5 is a schematic diagram of various modes of a master and a slave; and

FIG. 6 is a flowchart of a redundant management method of a server according to the second embodiment.

### DETAILED DESCRIPTION OF THE INVENTION

### First Embodiment

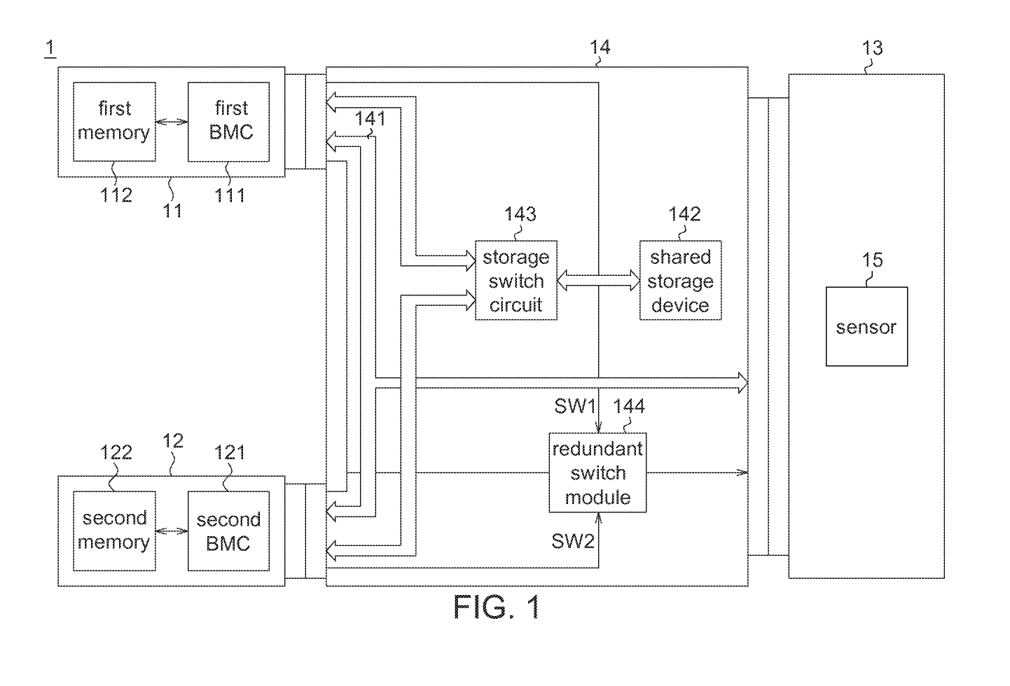

FIG. 1 shows a schematic diagram of a server system according to a first embodiment. Referring to FIG. 1, a server system 1 includes a first central management board (CMB) 11, a second CMB 12, a server 13, a redundant circuit board (RCB) 14, and a sensor 15. The server system 1 is apt to operate in collaboration with the sensor 15 and server 13. The RCB 14 includes a communication bus 141, a shared storage device 142, a storage switch circuit 143, and a redundant switch module 144. The communication bus 141 communicates the first CMB 11 with the second CMB 12, and is, for example, an I²C bus. The sensor 15 generates sensing data. The storage switch circuit 143 is controlled by the first CMB 11 or the second CMB 12 to accordingly connect the shared storage device 142 to the first CMB 11 or the second CMB 12. The first CMB 11 or the second CMB 12 outputs a control signal and acquires the system mastery of the server 13 via the redundant switch module 144.

For example, the control signal is an enable signal outputted by the first CMB 11 or the second CMB 12. The enable signal is transmitted to the server 13 via the RCB 14, and serves for activating or deactivating hardware of the server 13. The first CMB 11 includes a first baseboard management controller (BMC) 11 and a first memory 112. The first BMC 111 is connected to the first memory 112. The second CMB 12 includes a second BMC 121 and a second memory 122. The second BMC 121 is connected to the second memory 122. The communication bus 141 is connected to the first BMC 111 and the second BMC 121. Control signals of the first memory 112 and the second memory 122 need to be synchronized. For example, the sensing data includes voltage, current, power, temperature, fan speed and device properties read by the sensor. For example, the first BMC 111 or the second BMC 121 outputs the control signal according to the sensing data. For example, when the sensor 15 detects that power provided by a power supply of the server 13 is too large, the first BMC 111 or the second BMC 121 outputs the control signal to control the power supply to reduce the power. It should be noted that, abnormal sensing data of the first memory 112 and 122 also needs to be synchronized. For example, when the sensor 15 detects no abnormalities in the power provided by the power supply of the server 13, the first BCM 111 or the second BMC 121 does not perform any operation. In contrast, when the power provided by the power supply of the server 13 is abnormal, the first BMC 111 or the second BMC 121 registers the abnormal event of the power supply via a system event log (SEL) and stores the SEL to the first memory 112 or the second memory 122. Thus, abnormal sensing data needs to be synchronized between the first memory 112 and the second memory 122.

A hardware strapping of the first CMB 11 and the second CMB 12 and set on the RCB 14 may be utilized to determine which of the first CMB 11 and the second CMB 12 is prioritized for the acquisition of the system mastery of the server 13. For example, the hardware strapping indicates insertion addresses to which the first CMB 11 and the second CMB 12 correspond on the RCB 14. For example, assume the insertion address that the first CMB 11 corresponds on the RCB 14 is 00, and the insertion address that the second CMB 12 corresponds on the RCB 14 is 01. The priority gets higher as the insertion address gets smaller. Therefore, the above insertion addresses indicate that the first CMB 11 is the master, whereas the second CMB 12 is the slave controlled by the server 13. It should be noted that, the conditions for the first CMB 11 and the second CMB 12 to acquire the system mastery of the server 13 are not limited to the hardware strapping on the RCB 14, which is illustrated as an example in the disclosure.

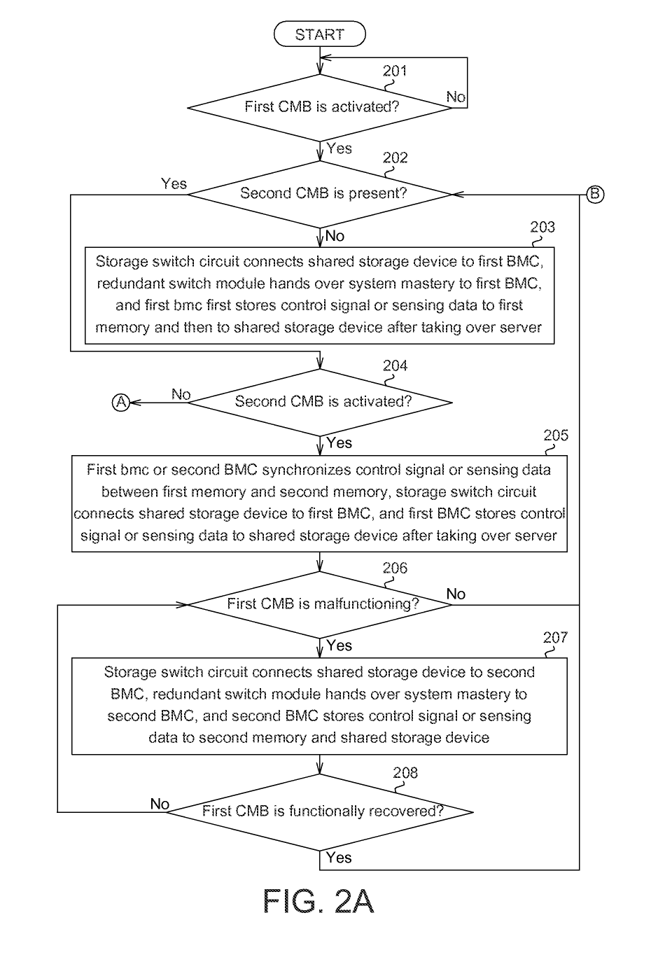

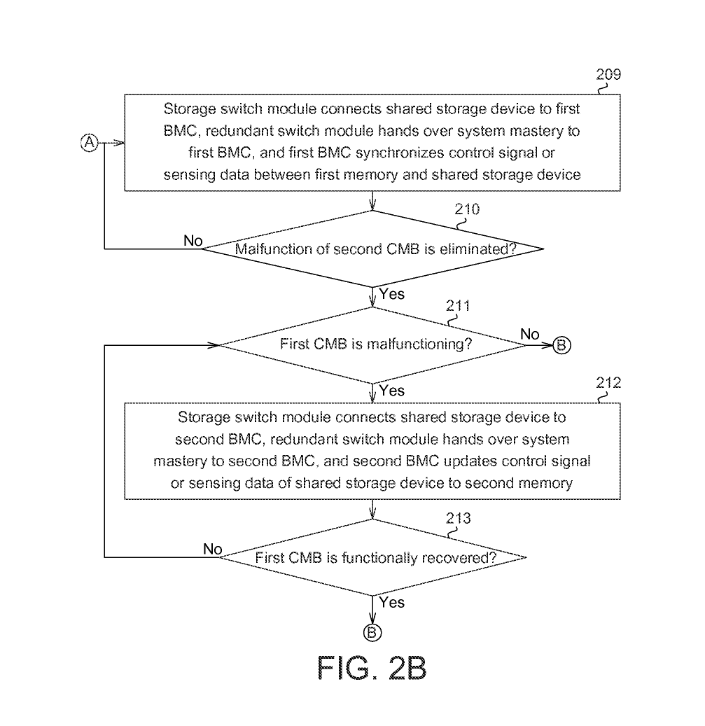

FIGS. 2A and 2B are flowcharts of a redundant management method of a server system according to the first embodiment. The redundant management method is described in detail with reference to FIGS. 1, 2A and 2B below. In step 201, it is determined whether the first CMB 11 is active. Step 201 is iterated when the first CMB 11 is not activated, or else step 202 is performed when the first CMB 11 is activated. In step 202, it is determined whether the second CMB 12 is present. Step 203 is performed when the second CMB 12 is not present. In step 203, the storage switch circuit 143 connects the shared storage device 142 to the first BMC 111, and the redundant switch module 144 hands the system mastery to the first BMC 111. After taking over the server 13, the first BMC 111 first synchronizes the control signal or sensing data between the first memory 112 and the shared storage device 142. More specifically, the first BMC 111 first stores the control signal or sensing data to the first memory 112 and then to the shared storage device 142.

Step 204 is performed when the second CMB 12 is present. In step 204, it is determined whether the second CMB 12 is activated. Step 205 is performed when the second CMB 12 is activated. In step 205, the first BMC 111 or the second BMC 121 synchronizes the control signal or sensing data between the first memory 112 and the second memory 122. The storage switch circuit 143 connects the shared storage device 142 to the first BMC 111. After taking over the server 13, the first BMC 111 stores the control signal or sensing data to the shared storage device 142.

In step 206, it is determined whether the first CMB 11 is malfunctioning. Step 202 is iterated when the first CMB 11 is not malfunctioning, or else step S207 is performed when the first CMB 11 is malfunctioning. In step 207, the storage switch circuit 143 connects the shared storage device 142 to the second BMC 121, the redundant switch module 144 hands the system mastery to the second BMC 121, and the second BMC 121 stores the control signal or sensing data to the second memory 122 and the shared storage device 142. In step 208, it is determined whether the first CMB 11 is functionally recovered. Step 202 is iterated when the first CMB 11 is recovered, or else step 206 is iterated when the first CMB 11 is not recovered.

In step 204, when the second CMB 12 is not activated, step 209 is performed. In step 209, the storage switch circuit 143 connects the shared storage device 142 to the first BMC 111, and the redundant switch module 144 hands the system mastery to the first BMC 111. The first BMC 111 synchronizes the control signal or sensing data between the first memory 112 and the shared storage device 142.

In step 210, it is determined whether the malfunction of the second CMB 12 is eliminated. Step 209 is iterated when the malfunction of the second CMB 12 is not eliminated, or else step 211 is performed when the malfunction of the second CMB 12 is eliminated and the second CMB 12 is again activated. In step 211, it is determined whether the first CMB 11 is malfunctioning. Step 202 is iterated when the first CMB 11 is not malfunctioning, or else step 212 is performed when the first CMB 11 is malfunctioning. In step 212, the storage switch circuit 143 connects the shared storage device 142 to the second BMC 121, and the redundant switch module 144 hands the system mastery to the second BMC 121. The second CMB 12 updates the control signal or sensing data of the shared storage device 142 to the second memory 122. Next, in step 213, it is determined whether the first CMB 11 is functionally recovered. Step 211 is iterated when the first CMB 11 is not recovered, or else step 202 is iterated when the first CMB 11 is recovered.

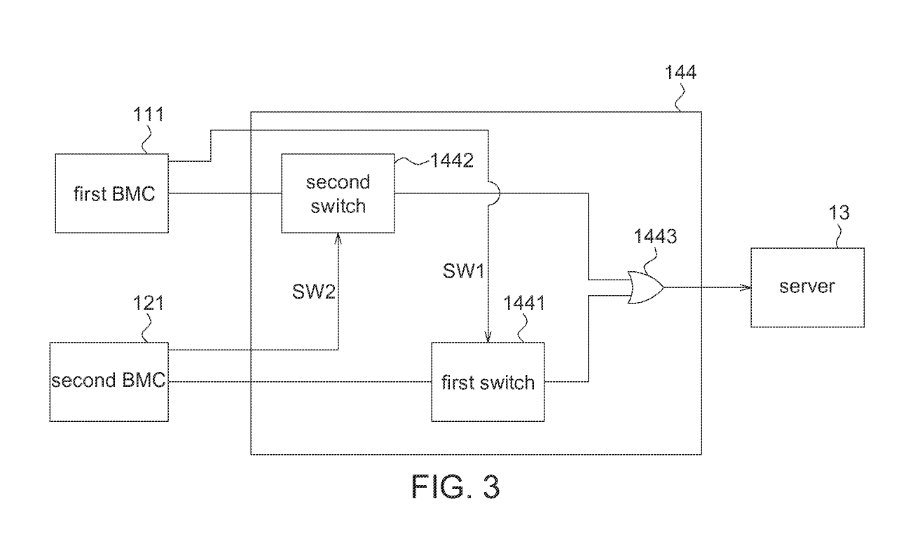

FIG. 3 shows a schematic diagram of the first BMC 111, the second BMC 121, the server 13 and the redundant switch module 144 according to the first embodiment. Referring to FIGS. 1 and 3, the redundant switch module 144 further includes a first switch 1441, a second switch 1442 and a logic gate 1443. The logic gate 1443 is connected to the first switch 1441 and the second switch 1442, and is an OR gate, for example. When the redundant switch module 144 is to hand the system mastery to the first BMC 111, the first BMC 111 outputs a first force signal SW1 to turn off the first switch 1441. As the first switch 1441 is turned off, the system mastery of the server 13 is acquired by the first BMC 111. Conversely, when the redundant switch module 144 is to hand the system mastery to the second BMC 121, the second BMC 121 outputs a second force signal SW2 to turn off the second switch 1442. As the second switch 1442 is turned off, the system mastery of the server 13 is acquired by the second BMC 121.

As such, the control signal and sensing data of the first CMB 11 and the second CMB 12 may be synchronized via the RCB 14. Such approach allows a user to provide the first CMB 11 or the second CMB 12 with redundant services via the RCB 14. That is to say, when software or hardware of the server 13 malfunctions, the RCB 14 assists the first CMB 11 or the second CMB 12 to monitor the temperature, voltage or hardware component such as fans. Therefore, in the occurrence of a malfunction of the first CMB 11 or the second CMB 12, the user is still capable of managing the server 13 at a remote terminal via the RCB 14.

### Second Embodiment

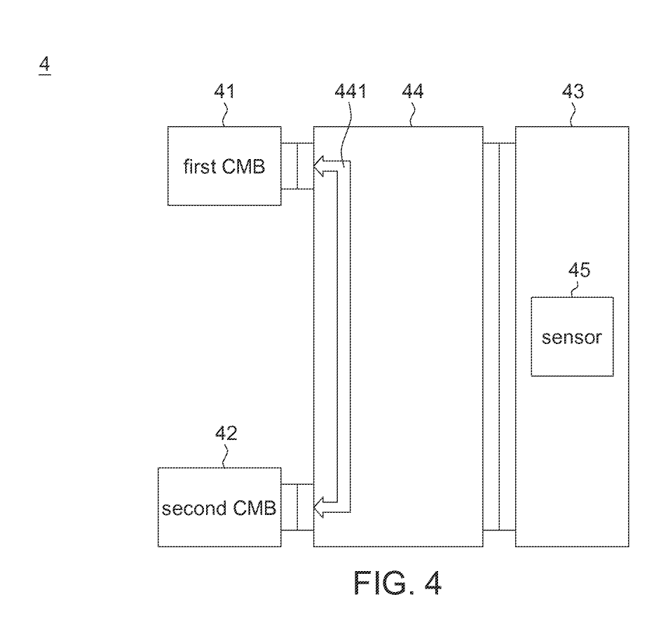

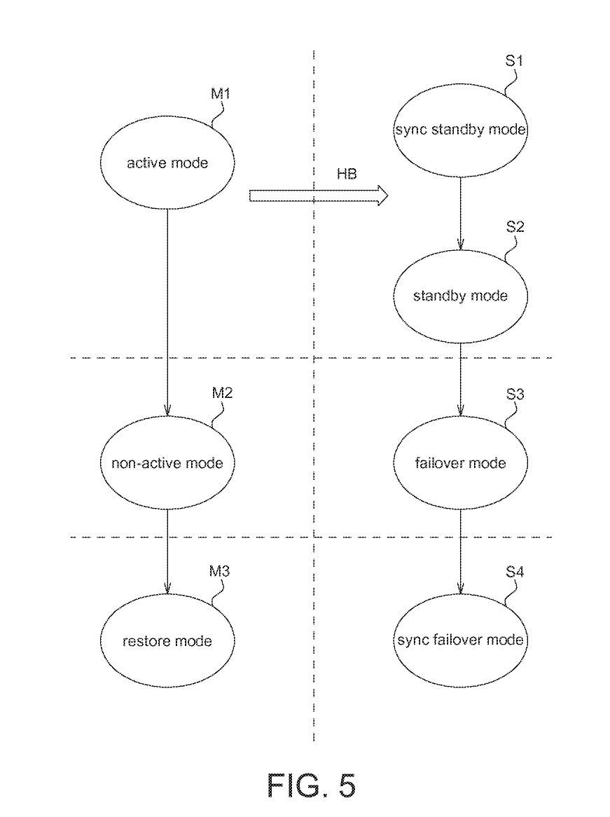

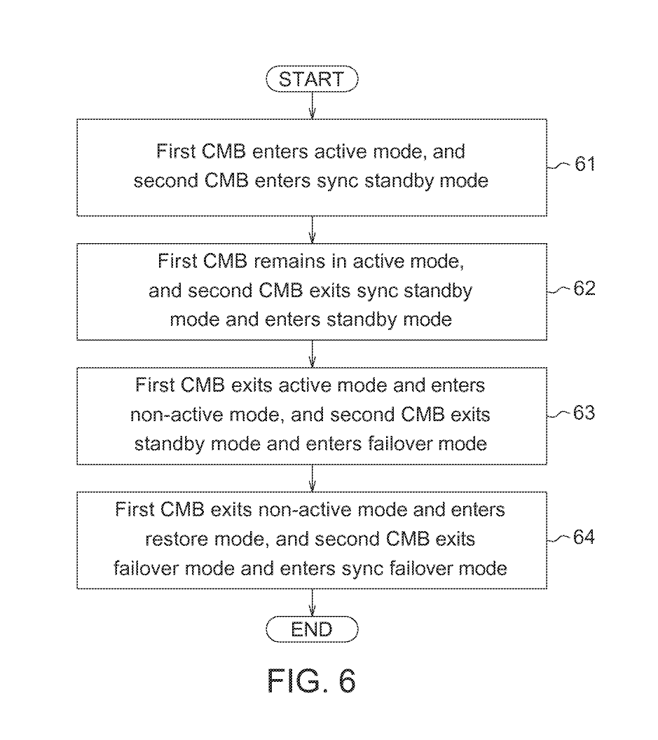

FIG. 4 shows a schematic diagram of a server system according to a second embodiment; FIG. 5 shows a schematic diagram of various modes of a master and a slave; FIG. 6 shows a flowchart of a redundant management method according to the second embodiment. Referring to FIG. 4, a server system 4 includes a first CMB 41, a second CMB 42, a server 43, an RCB 44, and a sensor 45. In an active mode, the first CMB 41 takes over the server 43. The server system 4 is apt to operate in collaboration with the sensor 45 and the server 43. The first CMB 41 and the second CMB 42 adopt the same Internet Protocol (IP) address. The RCB 44 includes a communication bus 441. The communication bus 441 communicates the first CMB 41 with the second CMB 42. For example, the communication bus 441 is an I²C bus, RS232, a printer bus or a Universal Serial Bus (USB). The sensor 45 generates sensing data, and is, for example, a temperature sensor that detects the temperature of the server 43, a voltage sensor that detects the supply voltage of the server 43, or a rotational speed sensor that detects the rotational speed of the fan of the server 43.

It should be noted that, the first CMB 41 and the second CMB 42 not only are mutually redundant but also shared the same IP address. With respect to a remote user, as the first CMB 41 and the second CMB 42 share the same IP address, the status data of the first CMB 41 and the second CMB 42 also needs to be identical, or else an error will be incurred. For example, in the occurrence of a malfunction, assuming that original date and time of the first CMB 41 and the second CMB 42 are inconsistent, the recorded time points at which the malfunction occurs are then unreliable that they cannot serve as a reference for associated determination. Therefore, when the first CMB 41 and the second CMB 42 share the same IP address, the status data of the first CMB 41 and the second CMB 42 needs to be synchronized.

Although the first CMB 41 and the second CMB 42 may share the same IP address, it does not necessarily mean that both of the first CMB 41 and the second CMB 42 are active. When both of the first CMB 41 and the CMB 42 are active, one of them is a real media access control (MAC) address while the other is a virtual MAC address. However, the real MAC address is the same as the virtual MAC address.

Referring to FIGS. 5 and 6, in step 61, the first CMB 41 enters an active mode M1, and the second CMB 42 enters a sync standby mode S1. When the first CMB 41 enters the active mode M1 and the second CMB 42 enters the sync standby mode S1, the first CMB 41 outputs a heartbeat signal HB to the second CMB 42, and synchronizes status data to the second CMB 42. In the active mode M1, the first CMB 41 takes over the server 43, and outputs a control signal to control the server 43.

For example, the status data is the date, time, firmware of the BMC, mode of a local area network (LAN) or IP parameter of the first CMB 41. When the first CMB 41 enters the active mode M1, the first CMB 41 is a master while the second CMB 42 is a slave. That is, the first CMB 41 is capable of reading the sensing data and responding to a user instruction, whereas the second CMB 42 is capable of only reading the sensing data but not responding to a user instruction.

When the data amount of the status data is small, e.g., when the status data is the setting for the date, time, LAN mode or IP parameter, the BMC of the first CMB 41 stores the status data to a temporary memory of the second CMB 42, and the BMC of the second CMB 42 then performs the update and synchronization according to the data in the temporary memory of the second CMB 42. When the data amount of the status data is large, e.g., when the status data is firmware of the BMC, the BMC of the first CMB 41 needs to first store the status data into a permanent memory device, and then updates the firmware in the BMC of the second CMB 42 by way of firmware refresh to complete the synchronization.

In step 62, the first CMB 41 remains in the active mode M1, and the second CMB 42 exits the sync standby mode S1 and enters a standby mode S2. After the first CMB 41 synchronizes management information to the second CMB 42, the first CMB 41 remains in the active mode M1, and the second CMB 42 exits the sync standby mode S1 and enters the standby mode S2. After the second CMB 42 enters the standby mode S2, the first CMB 41 no longer synchronizes the management information with the second CMB 42. At this point, the first CMB 41 reads the sensing data and responds to a user instruction, whereas the second CMB 42 reads the sensing data but does not respond to a user instruction. When the sensor 45 senses an abnormal situation, the second CMB 42 records the abnormal situation to the SEL.

In step 63, the first CMB 41 exits the active mode M1 and enters a non-active mode M2, and the second CMB 42 exits the standby mode S2 and enters a failover mode S3. When the first CMB 41 malfunctions, the first CMB 41 does not output a heartbeat signal HB to the second CMB 42. When the second CMB 42 does not receive the heartbeat signal HB in the standby mode S2, the first CMB 41 exits the active mode M1 and enters the non-active mode M2, and the second CMB 42 exits the standby mode S2 and enters the failover mode S3, and further takes over the server 43 in the failover mode S3. In the standby mode S2, the second CMB 42 reads the sensing data and responds to a user instruction.

In step 64, the first CMB 41 exits the non-active mode M2 and enters a restore mode M3, and the second CMB 42 exits the failover mode S3 and enters a sync failover mode S4. When the first CMB 41 recovers from the malfunction, the first CMB 41 again outputs the heartbeat signal HB to the second CMB 42. When the second CMB 42 receives the heartbeat signal HB in the failover mode S3, the first CMB 41 exits the non-active mode M2 and enters the restore mode M3, and the second CMB 42 exits the sync failover mode S4 to synchronize the management information to the first CMB 41. The first CMB 41, in the restore mode M3, does not read the sensing data or respond to a user instruction, whereas the second CMB 42, in the sync failover mode S4, reads the sensing data and responds to a user instruction.

After the second CMB 42, in the sync failover mode S4, synchronizes the management information to the first CMB 41, there are two options. One of the options is to exchange the roles of the first CMB 41 and the second CMB 42, i.e., the first CMB 41 is changed from being the master to the slave, and the second CMB 42 is changed from being the slave to the master.

The other option is to have the first CMB 41 again take over the server 43. After the second CMB 42, in the sync failover mode S4, synchronizes the management information to the first CMB 41, the first CMB 41 exits the restore mode M3 and enters the active mode M1, and the second CMB 42 exits the sync failover mode S4 and enters the sync standby mode S1. At this point, the first CMB 41 is capable of reading the sensing data and responding to a user instruction, whereas the second CMB 42 is capable of only reading the sensing data but not responding to a user instruction.

As disclosed, in the server system 4 according to the embodiment, the status data is synchronized between the first CMB 41 and the second CMB 42 in a situation where the first CMB 41 and the second CMB 42 share the same IP address, thereby reinforcing the redundant management capability of the first CMB 41 and the second CMB 42. Meanwhile, it is ensured that the status data in the first CMB 41 and the second CMB 42 is consistent, so that the ability for correctly managing the server 13 by a remote user can be enhanced.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A server system, apt to operate in collaboration with a server and a sensor that generates sensing data, comprising:
a first central management board (CMB);
a second CMB; and
a redundant circuit board (RCB), comprising:
a communication bus, configured to communicate the first CMB with the second CMB;
a shared storage device;
a storage switch circuit, controlled by the first CMB or the second CMB to connect the shared storage device to the first CMB or the second CMB; and
a redundant switch module, via which the first CMB or the second CMB outputs a control signal to acquire a system mastery of the server.

2. The server system according to claim 1, wherein the first CMB comprises a first baseboard management controller (BMC) and a first memory, with the first BMC connected to the first memory; the second CMB comprises a second BMC and a second memory, with the second BMC connected to the second memory; and the communication bus is connected to the first BMC and the second BMC.

3. The server system according to claim 2, wherein the first CMB is a master controlling the server and the second CMB is a slave controlled by the server.

4. The server system according to claim 3, wherein when the first CMB is activated and the second CMB is not activated, the storage switch circuit connects the shared storage device to the first BMC, the redundant switch module hands the system mastery to the first BMC, and the first BMC synchronizes the control signal or the sensing signal between the first memory and the shared storage device.

5. The server system according to claim 4, wherein when a malfunction of the second CMB is eliminated and the first CMB malfunctions after being activated, the storage switch circuit connects the shared storage device to the second BMC, the redundant switch module hands the system mastery to the second BMC, and the second BMC updates the control signal or the sensing data of the shared storage device to the second memory.

6. The server system according to claim 5, wherein the second CMB stores the control signal or the sensing data to the shared storage device and the second memory after taking over the server.

7. The server system according to claim 3, wherein when the first CMB and the second CMB are activated, the first BMC or the second BMC synchronizes the control signal or the sensing data between the first memory and the second memory, the storage switch circuit connects the shared storage device to the first BMC, and the first BMC stores the control signal or the sensing data to the shared storage device after taking over the server.

8. The server system according to claim 7, wherein when the first CMB malfunctions after being activated, the storage switch circuit connects the shared storage device to the second BMC, the redundant switch module hands the system mastery to the second BMC, and the second BMC stores the control signal or the sensing data to the second memory and the shared storage device.

9. A server system, apt to operate in collaboration with a server and a sensor that generates sensing data, comprising:
a CMB;
a second CMB, the first CMB and the second CMB being connected to the sensor; wherein, when the first CMB enters an active mode and the second CMB enters a sync standby mode, the first CMB outputs a heartbeat signal to the second CMB and synchronizes status data to the second CMB, and the first CMB, in the active mode, further takes over the server and outputs a control signal to control the server; and
a RCB, comprising:
a communication bus, configured to communicate the first CMB with the second CMB.

10. The server system according to claim 9, wherein after the first CMB synchronizes the status data to the second CMB, the first CMB remains in the active mode, and the second CMB exits the sync standby mode and enters a standby mode.

11. The server system according to claim 10, wherein when the second CMB, in the standby mode, does not receive the heartbeat signal, the first CMB exits the active mode and enters a non-active mode; and the second CMB exits the standby mode and enters a failover mode, and, in the failover mode, takes over the server.

12. The server system according to claim 11, wherein when the second CMB receives the heartbeat signal in the failover mode, the first CMB exits the non-active mode and enters a restore mode, the second CMB exits the failover mode and enters a sync failover mode, and the second CMB, in the sync failover mode, synchronizes the status data to the first CMB.

13. The server system according to claim 12, wherein after the second CMB synchronizes the status data to the first CMB in the sync failover mode, the first CMB changes from being a master to a slave, and the second CMB changes from being the slave to the master.

14. The server system according to claim 12, wherein after the second CMB synchronizes the status data to the first CMB in the sync failover mode, the first CMB exits the restore mode and enters the active mode, and the second CMB exits the sync failover mode and enters the sync standby mode.

15. A redundant management method for a server system, the server system comprising a sensor, a first CMB, a second CMB and an RCB, the RCB comprising a communication bus, the communication bus for communicating the first CMB with the second CMB; the redundant management method comprising:
generating sensing data by the sensor; and
when the first CMB enters an active mode and the second CMB enters a sync standby mode, the first CMB outputs a heartbeat signal to the second CMB and synchronizes status data to the second CMB, and the first CMB, in the active mode, takes over the server and outputs a control signal to control the server.

16. The redundant management method according to claim 15, wherein after the first CMB synchronizes the status data to the second CMB, the first CMB remains in the active mode, and the second CMB exits the sync standby mode and enters a standby mode.

17. The redundant management method according to claim 16, wherein when the second CMB, in the standby mode, does not receive the heartbeat signal, the first CMB exits the active mode and enters a non-active mode; and the second CMB exits the standby mode and enters a failover mode, and, in the failover mode, takes over the server.

18. The redundant management method according to claim 17, wherein when the second CMB receives the heartbeat signal in the failover mode, the first CMB exits the non-active mode and enters a restore mode, the second CMB exits the failover mode and enters a sync failover mode, and the second CMB, in the sync failover mode, synchronizes the status data to the first CMB.

19. The redundant management method according to claim 18, wherein after the second CMB synchronizes the status data to the first CMB in the sync failover mode, the first CMB changes from being a master to a slave, and the second CMB changes from being the slave to the master.

20. The redundant management method according to claim 18, wherein after the second CMB synchronizes the status data to the first CMB in the sync failover mode, the first CMB exits the restore mode to the active mode, and the second CMB exits the sync failover mode and enters the sync standby mode.
